(19) United States
(12) Patent Application Publication
(10) Pub. No.: US 2013/0040495 A1
(43) Pub. Date: Feb. 14, 2013

(54) Electrical Outlet Cover and Method of Use Thereof

(71) Applicant: J. Moss, Alpharetta, GA (US)

(72) Inventor: J. Moss, Alpharetta, GA (US)

(21) Appl. No.: 13/208,574

(22) Filed: Aug. 12, 2011

(51) Int. Cl. H01R 13/46; B23P 6/00; H02G 3/14

(52) U.S. Cl. 439/625; 174/66; 29/592.1

(57) ABSTRACT

A cover for an electrical outlet that has a front with a socket having apertures dimensioned to accept the blades of an electrical plug. The electrical outlet cover is formed as a thin conforming surface that has plug slots therein that align with the socket. The plug slots are dimensioned to permit the blades of the plug to pass therethrough, and the thin surface extends over the front of the electrical outlet entirely except for its socket apertures.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to covers for electrical outlets, and more specifically to a cover that permits use of the electrical outlet while the cover is in place.

2.Description of Related Art

Often during reconstruction/renovation of a home or commercial building, electrical outlets need to be replaced due to poor cosmetic appearance, even though the outlet is fully functional. While the outlet may be fully functional, it may have chips, paint or other cosmetic blemishes that require removal of the outlet and replacement with a new clean, undamaged outlet.

Further, a homeowner may find that an electrical socket, through wear, has loosened and does not retain a plug inserted thereinto firmly, and it is desirous to tighten the electrical socket without having to replace it. Moreover, it may be desired to change the appearance of the electrical socket to match a color scheme, or other decor, of a room.

The above deficiencies necessitate removal of electricity from the outlet to avoid hazardous conditions, and subsequent removal and replacement of the outlet, thereby increasing the cost of the renovation. Unfortunately, with existing technology, an outlet has a cover plate that surrounds the faces with their electrified slots, which when removed and replaced, results in the existing faces remaining visible.

Therefore, it is readily apparent that there is a need for an electrical outlet cover and/or cover plate with outlet face covers therein for covering the existing faces of an electrical outlet to provide for easy, safe and rapid renovation of the electrical outlet.

### BRIEF SUMMARY OF THE INVENTION

Briefly described, in a preferred embodiment, the present invention overcomes the above-mentioned disadvantages and meets the recognized need for such a device by providing a cover for an electrical outlet that has a front with a socket having apertures dimensioned to accept the blades of an electrical plug. The electrical outlet cover is formed as a thin conforming surface that has plug slots therein that align with the socket apertures. The plug slots are dimensioned to permit the blades of the plug to pass therethrough, and the thin surface extends over the front of the electrical outlet entirely except for its socket apertures.

According to its major aspects and broadly stated, the present invention in its preferred form is a cover for an electrical outlet that has a front with electrified socket apertures therein dimensioned to accept the blades of an electrical plug. The electrical outlet cover comprises a thin surface with plug slots therein, wherein the plug slots align with the socket apertures of the electrical outlet, and the plug slots are dimensioned to permit the blades of the plug to pass through. The thin surface extends over, and covers, the front of the electrical outlet entirely except for the socket apertures, thereby renovating the electrical outlet. The electrical outlet cover also has a throughhole for receiving a screw to secure a cover plate over the electrical outlet cover, and the cover plate has openings in it dimensioned to receive the front of the electrical outlet that is covered by the thin surface.

The electrical outlet cover may be dimensioned for a duplex electrical outlet, and in this configuration, the electrical outlet has two front sections with socket apertures disposed in each of the front sections. The thin surface covers the two fronts entirely except for the socket apertures. The thin surface comprises two face portions, each of which covers a respective one of the two fronts. The two face portions are connected via a thin strip, the two face portions and the thin strip being formed in integrity. The thin strip further comprises a throughhole for receiving a screw to secure a cover plate over the electrical outlet cover.

The electrical outlet may comprise a quadruplex outlet with four fronts having socket apertures disposed in each of the fronts. The thin surface accordingly has four face portions integrally-molded together and covers the four fronts entirely except for the socket apertures, with each of the four face portions covering a respective one of the four fronts.

The thin surface may alternatively be formed in integrity together with a cover plate, thereby rendering the electrical outlet cover and the cover plate into a single unitary construction.

Further described is a method of changing the appearance of an electrical outlet in which an electrical outlet cover comprising a thin surface with slots therein is obtained, wherein said slots align with socket apertures disposed in the electrical outlet. The electrical outlet has at least one front with slots therein that are dimensioned to permit the blades of an electrical plug to pass through. The thin surface extends over the front of the electrical outlet entirely except for the socket apertures. The electrical outlet cover is secured over the electrical outlet to form a combination, and a cover plate is secured over the combination via a screw by inserting the screw within a throughhole in the thin surface.

More specifically, the present invention is a decorative electrical outlet cover or cover plate with an insert for covering the faces of an electrical outlet. The electrical outlet cover is a thin surface having face portions, plug slots, sidewalls and a connecting member between the face portions. The face portions are defined by their respective sidewalls, and the connecting member has a throughhole for a screw. The electrical outlet cover is made of an insulating polymeric material, such as, for exemplary purposes only, polystyrene, polyethylene, polypropylene, polycarbonate and the like and is preferably formed as thinly as possible, having only a thickness adequate to provide opacity when a pigment is added to the polymeric or other material.

The shape of the electrical outlet cover is defined by the fronts and sides of the fronts of the electrical outlet, and the face portions are preferably molded to form fit on, and tightly conform around, the fronts and sides. It will be recognized by those skilled in the art that the electrical outlet cover could comprise one face portion defined by sidewalls, or a plurality of face portions defined by their respective sidewalls.

In use, where renovation of an electrical outlet is taking place, the outlet is typically found disposed within an electrical box with a cover plate over it. The cover plate is removed from the electrical outlet by removing its screw. Subsequently, the electrical outlet cover is placed over the fronts and sides of the electrical outlet in close proximity to the fronts and sides so that the plug slots of the electrical outlet cover are in alignment with the respective socket apertures of the electrical outlet, and the throughhole of the electrical outlet cover is in alignment with the threaded receptacle of electrical outlet.

Next, the cover plate, which has openings dimensioned to receive the face portions covering the fronts and the cover plate, is disposed over the combined electrical outlet cover/electrical outlet with the face portions in combination with fronts and sides being disposed within the openings. The cover plate is secured to the electrical outlet via a screw, and the electrical outlet cover is retained in place over the electrical outlet with the plug slots aligned with the socket apertures.

The electrical outlet cover has slots that are slightly narrower and shorter than the socket apertures, and when the electrical plug is engaged with the socket apertures, the slots provide further stability to the blades and help retain the blades within the electrical outlet.

In an alternate embodiment, the cover plate includes the face portions and plug slots molded together as a single unit cover plate.

In another embodiment, the cover plate is a duplex cover plate, again having molded-in face portions, plug slots, and a screwhole. The face portions are dimensioned to tightly and conformingly cover the fronts and sides of the electrical outlet. In use, the existing cover plate is removed from a standard duplex outlet and is replaced by a duplex cover plate, wherein the duplex cover plate is secured to the electrical outlet via a screw.

In yet another alternate embodiment, the quadruplex electrical cover plate has face portions, plug slots, and screwholes. Similarly to the preferred and alternate embodiments referenced hereinabove, the quadruplex cover plate is installed over a quadruplex electrical outlet by removal of the existing cover plate and replacement of same by the quadruplex cover plate. In use, for a quadruplex outlet having a cover plate secured by screws, the existing cover plate is removed from the quadruplex outlet and the cover plate is replaced by the quadruplex cover plate which is secured to the quadruplex outlet via screws.

Accordingly, a feature and advantage of the present invention is its ability to provide renovation of electrical outlets without removal of the electrical socket and electrical wiring, and without the need to remove electrical current.

Another feature and advantage of the present invention is its ability to repair cosmetic deficiencies of existing electrical outlets.

Still another feature and advantage of the present invention is its ability to provide a changeable surface decoration or pattern for an electrical outlet.

Yet another feature and advantage of the present invention is its ability to be safely added to an electrical outlet.

Yet still another feature and advantage of the present invention is its ability to assist in retention of plugs in electrical outlet sockets.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, which are not necessarily drawn to scale, and in which like reference numerals denote similar structure and refer to like elements throughout, and in which:

FIG. 1 is a front perspective view of an electrical outlet cover according to a preferred embodiment, shown disposed over an electrical outlet with an electrical outlet cover plate installed thereover;

FIG. 2 is an exploded view of the electrical outlet cover, electrical outlet and electrical outlet cover plate of the preferred embodiment of FIG. 1;

FIG. 3A is a front view of a combined duplex electrical outlet cover and cover plate according to an alternate embodiment; and

FIG. 3B is a front view of a combined quadruplex electrical outlet cover and cover plate according to an alternate embodiment.

### DETAILED DESCRIPTION OF THE PREFERRED AND SELECTED ALTERNATE EMBODIMENTS OF THE INVENTION

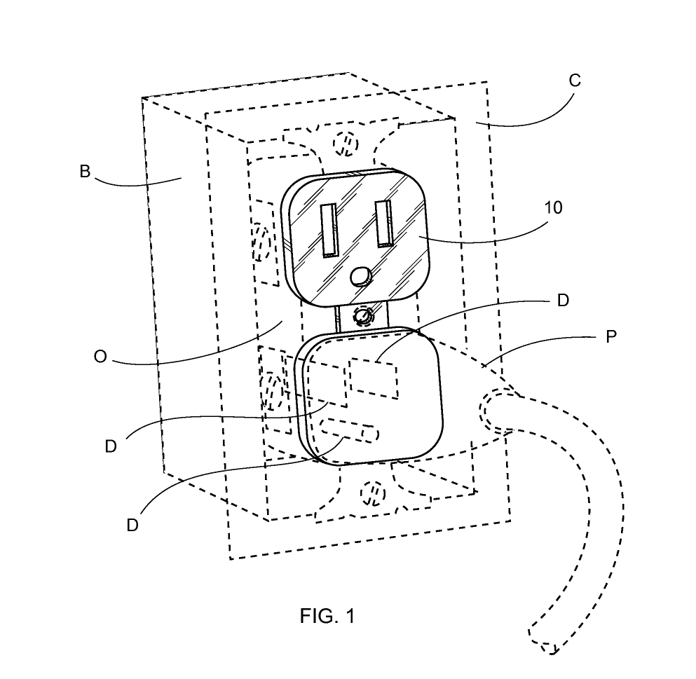

In describing the preferred and selected alternate embodiments of the present invention, as illustrated in FIGS. 1-3B, specific terminology is employed for the sake of clarity. The invention, however, is not intended to be limited to the specific terminology so selected, and it is to be understood that each specific element includes all technical equivalents that operate in a similar manner to accomplish similar functions.

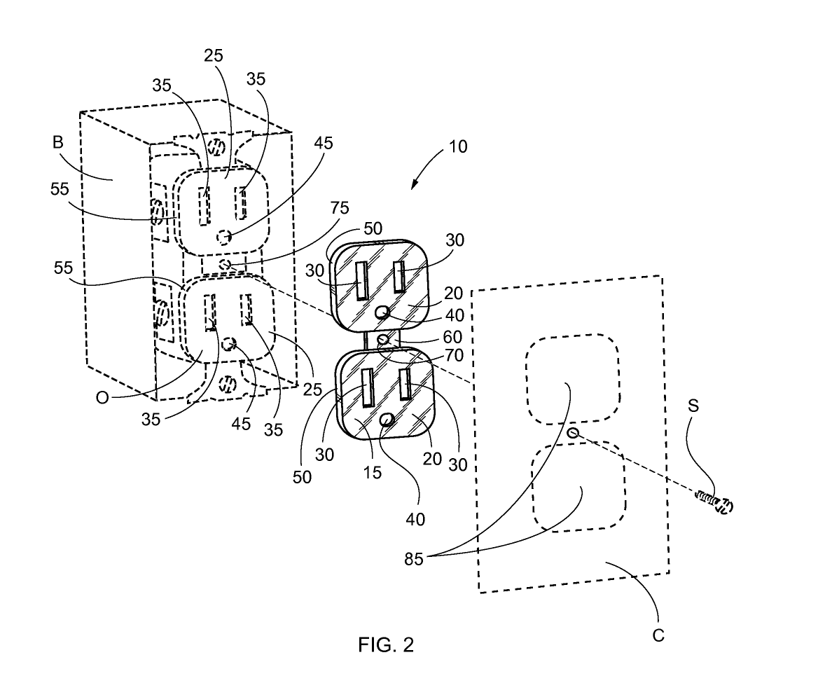

Referring now to FIGS. 1-2, the present invention in a preferred embodiment is electrical outlet cover 10 for covering electrical outlet O, wherein electrical outlet cover 10 preferably comprises thin surface 15 having face portions 20, plug slots 30, 40, sidewalls 50 and connecting member 60, and wherein face portions 20 are preferably defined by their respective sidewalls 50, and wherein connecting member 60 preferably comprises throughhole 70 therein, and wherein connecting member 60 is disposed between and connects face portions 20. It will be noted that plug slots 30, 40 typically comprise power and ground, respectively. Electrical outlet cover 10 preferably comprises an insulating polymeric material, such as, for exemplary purposes only, polystyrene, polyethylene, polypropylene, polycarbonate and the like and is preferably formed as thinly as possible, having only a thickness adequate to provide opacity when a pigment is added to the polymeric material.

Electrical outlet cover 10 preferably comprises a shape defined by fronts 25 and sides 55 of electrical outlet O, and face portions 20 are preferably molded to form fit on, and tightly conform around, fronts 25 and sides 55. It will be recognized by those skilled in the art that electrical outlet cover 10 could comprise one face portion 20 defined by sidewall 50, or a plurality of face portions 20 defined by their respective sidewalls 50.

In use, particularly where electrical outlet O is to be renovated and is disposed within electrical box B, cover plate C is preferably removed from electrical outlet O, having been typically retained thereon via screw S. Subsequently, electrical outlet cover 10 is preferably disposed in close proximity to and over fronts 25 and sides 55 of electrical outlet O, wherein plug slots 30, 40 are preferably disposed in alignment with respective socket apertures 35, 45 of electrical outlet O, and wherein throughhole 70 is preferably disposed in alignment with threaded receptacle 75 of electrical outlet O.

Cover plate C preferably comprises openings 85 dimensioned to receive face portions 20 that are covering fronts 25, and cover plate C is preferably disposed over combined electrical outlet cover 10/electrical outlet O, wherein face portions 20 in combination with fronts 25 and sides 55 are disposed within openings 85, and wherein cover plate C is preferably secured to electrical outlet O via screw S, and wherein electrical outlet cover 10 is preferably retained in place over electrical outlet O with plug slots 30, 40 preferably retained in alignment with socket apertures 35, 45, respectively.

Electrical outlet cover 10 has slots 30, 40 that are slightly narrower and shorter than socket apertures 35, 45, and when electrical plug P is engaged with socket apertures 35, 45, slots 30, 40 provide further stability to blades D and further additively complement retention of blades D within electrical outlet O.

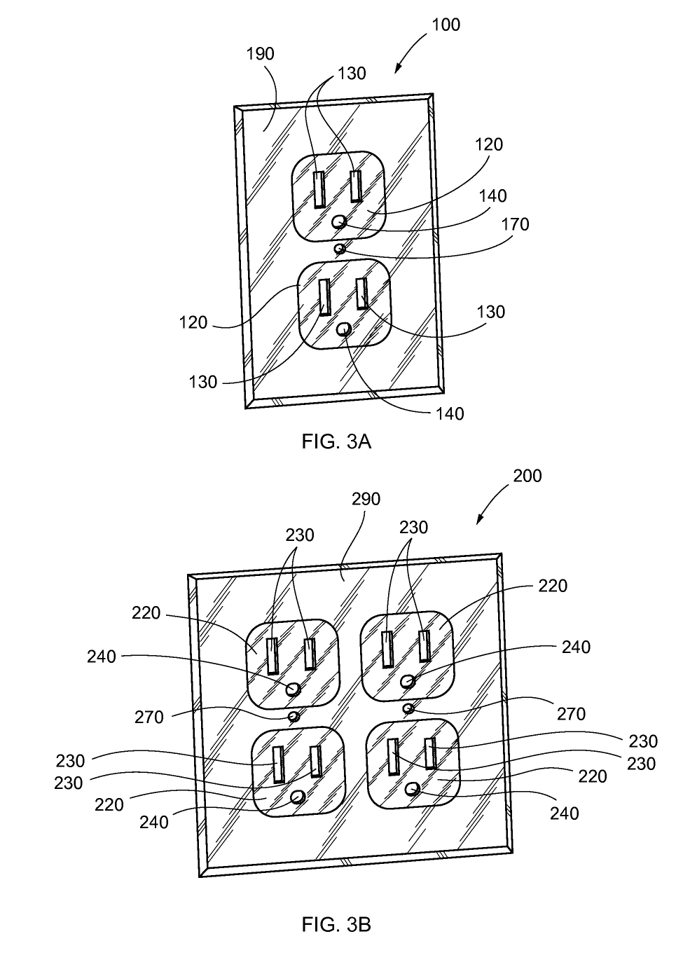

Referring now more specifically to FIG. 3A, illustrated therein is an alternate embodiment of electrical outlet cover 10, wherein the alternate embodiment of FIG. 3A is substantially equivalent in form and function to that of the preferred embodiment detailed and illustrated in FIGS. 1-2 except as hereinafter specifically referenced. Specifically, the embodiment of FIG. 3A comprises duplex cover plate 100, wherein duplex cover plate 100 comprises face portions 120, plug slots 130, 140, screwhole 170 and surface 190. Face portions 120 are dimensioned to tightly and conformingly cover fronts 25 and sides 55 of electrical outlet O (best shown in FIG. 2).

In use, cover plate C is removed from a standard duplex outlet, such as electrical outlet O (best shown in FIG. 2) and cover plate C is replaced by duplex cover plate 100, wherein duplex cover plate 100 is secured to electrical outlet O via screw S.

Referring now more specifically to FIG. 3B, illustrated therein is an alternate embodiment of electrical outlet cover 10, wherein the alternate embodiment of FIG. 3B is substantially equivalent in form and function to that of the preferred embodiment detailed and illustrated in FIGS. 1-2 except as hereinafter specifically referenced. Specifically, the embodiment of FIG. 3B comprises quadruplex cover plate 200, wherein quadruplex cover plate 200 comprises face portions 220, plug slots 230, 240, screwholes 270 and surface 290.

Similarly to the preferred and alternate embodiments referenced hereinabove for electrical outlet O, quadruplex cover plate 200 is installed over a quadruplex electrical outlet (not shown) by removal of the existing cover plate and replacement of same by quadruplex cover plate 200.

In use, for a quadruplex outlet having a cover plate secured by screws S, the cover plate is removed from the quadruplex electrical outlet and the cover plate is replaced by quadruplex cover plate 200, wherein quadruplex cover plate 200 is secured to the quadruplex elecrical outlet via screws S.

It will be recognized by those skilled in the art that electrical outlet cover 10 and cover plates 100 and 200 could be sized to conform to any size or shape electrical socket or group of sockets.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A cover for an electrical outlet, the electrical outlet having at least one front with socket apertures therein dimensioned to accept blades of an electrical plug, said electrical outlet cover comprising:
a thin surface having plug slots therein, wherein said plug slots align with the socket apertures of the electrical outlet, and wherein said plug slots are dimensioned to permit the blades of the plug to pass therethrough, and wherein said thin surface extends over the at least one front of the electrical outlet entirely except for said socket apertures, thereby covering the at least one front.

2. The electrical outlet cover of claim 1, further comprising a throughhole for receiving a screw, wherein said screw secures a cover plate over said electrical outlet cover, and wherein said cover plate has openings therein dimensioned to receive said at least one front.

3. The electrical outlet cover of claim 1, wherein the electrical outlet comprises a duplex outlet, and wherein the at least one front comprises two fronts with socket apertures disposed in each of the two fronts, and wherein said thin surface covers said two fronts entirely except for said socket apertures.

4. The electrical outlet cover of claim 3, wherein said thin surface comprises two face portions, and wherein one each of said two face portions covers a respective one of the two fronts, and wherein said two face portions are connected via a thin strip, and wherein said two face portions and said thin strip are formed in integrity.

5. The electrical outlet cover of claim 4, wherein said thin strip further comprises a throughhole for receiving a screw, and wherein said screw secures a cover plate over said electrical outlet cover.

6. The electrical outlet cover of claim 1, wherein the electrical outlet comprises a quadruplex outlet, and wherein the at least one front comprises four fronts with socket apertures disposed in each of the fronts, and wherein said thin surface covers the four fronts entirely, excluding the socket apertures.

7. The electrical outlet cover of claim 6, wherein said thin surface comprises four face portions, and wherein one each of said four face portions covers a respective one of the four fronts.

8. The electrical outlet cover of claim 7, wherein said four face portions are integrally-molded together.

9. The electrical outlet cover of claim 7, further comprising at least one throughhole dimensioned to receive a screw, wherein said screw secures a cover plate over said electrical outlet cover.

10. The electrical outlet cover of claim 1, wherein said thin surface is formed in integrity with a cover plate.

11. The electrical outlet of claim 3, wherein said thin surface is integrally-molded together with a cover plate.

12. The electrical outlet of claim 7, wherein said thin surface is integrally-molded together with a cover plate.

13. A method of changing the appearance of an electrical outlet, said method comprising the steps of:
obtaining an electrical outlet cover comprising a thin surface with slots therein, wherein said slots align with socket apertures disposed in the electrical outlet, and wherein the electrical outlet has at least one front, and wherein said slots are dimensioned to permit blades of an electrical plug to pass therethrough, and wherein said thin surface extends over the at least one front of the electrical outlet entirely except for the socket apertures;
securing said electrical outlet cover over the electrical outlet to form a combination; and
securing a cover plate over said combination via at least one screw.

14. The method of claim 13, wherein said thin surface comprises a throughhole for receiving said at least one screw, and wherein said step of securing a cover plate further comprises the step of:
securing said cover plate by inserting said at least one screw within said throughhole.

15. The method of claim 13, wherein the at least one front comprises two fronts, and wherein said thin surface comprises two face portions, and wherein one of each of said two face portions is disposed over a respective one of said two fronts, and wherein said two face portions are connected via a thin strip formed in integrity with said two face portions, and wherein at least one throughhole is disposed within said thin strip, and wherein said step of securing a cover plate further comprises the step of:
inserting said at least one screw within said at least one throughhole.

16. The method of claim 13, wherein the at least one front comprises four fronts, and wherein said thin surface comprises four face portions, one of each of said four face portions is disposed over a respective one of said four fronts, and wherein said four face portions are integrally-molded together into a unit, and wherein at least one throughhole is disposed within said unit, and wherein said step of securing a cover plate further comprises the step of:
inserting said at least one screw within said at least one throughhole.

17. A renovated electrical outlet comprising:
an electrical outlet having at least one front with electrified socket apertures therein for receiving an electrical plug;
an electrical outlet cover comprising a thin surface dimensioned to extend entirely over said at least one front, wherein said electrical outlet cover comprises slots aligned with said electrified socket apertures; and
a cover plate.

18. The renovated electrical outlet of claim 17, wherein said electrical outlet cover and said cover plate are integrally-molded together.

19. The renovated electrical outlet of claim 17, wherein said at least one front comprises two fronts, and wherein said thin surface comprises two face portions, each of which covers a respective one of said two fronts.

20. The renovated electrical outlet of claim 17, wherein said at least one front comprises four fronts, and wherein said thin surface comprises four face portions, each of which covers a respective one of said four fronts.
